(19) United States
(12) Patent Application Publication
(10) Pub. No.: US 2025/0241378 A1
(43) Pub. Date: Jul. 31, 2025

(54) ATOMIZATION APPARATUS CONTROL METHOD AND ATOMIZATION APPARATUS

(71) Applicant: SHENZHEN SMOORE TECHNOLOGY LIMITED, Shenzhen (CN)

(72) Inventors: Chengyong ZHOU, Shenzhen (CN); Chaozheng ZHANG, Shenzhen (CN); Sanying YU, Shenzhen (CN)

(21) Appl. No.: 19/024,292

(22) Filed: Jan. 16, 2025

(30) Foreign Application Priority Data
Jan. 30, 2024 (CN) 202410131603.9

(51) Int. Cl. A24F 40/57; A24F 40/46; A24F 40/53; G05B 15/02; H05B 1/02

(52) U.S. Cl. CPC A24F 40/57; A24F 40/46; A24F 40/53; G05B 15/02; H05B 1/0244; H05B 2203/005

(57) ABSTRACT

An atomization apparatus control method for an atomization apparatus that has at least two heating elements includes: obtaining a battery level parameter of the atomization apparatus; and if the battery level parameter is less than a preset threshold, controlling the atomization apparatus to work in a single-heating element mode in which one heating element of the includes at least two heating elements works, or if the battery level parameter is greater than or equal to the preset threshold, controlling the atomization apparatus to work in a multi-heating element mode in which the at least two heating elements work simultaneously.

### CROSS-REFERENCE TO PRIOR APPLICATION

Priority is claimed to Chinese Patent Application No. 202410131603.9, filed on Jan. 30, 2024, the entire disclosure of which is hereby incorporated by reference herein.

### FIELD

This application relates to the technical field of atomization apparatuses, and in particular, to an atomization apparatus control method and an atomization apparatus.

### BACKGROUND

An atomization manner of an atomization apparatus is as follows: A heating wire in an atomizer is heated to the atomization temperature of an aerosol-forming medium, so that the aerosol-forming medium is atomized to generate an aerosol for use by a user.

With continuous changes of user needs, when an original single-heating wire atomization apparatus works for a long time, a substance generated by an atomization medium is deposited on the heating wire, which affects normal working of the heating wire.

In this background, an atomization apparatus containing double heating wires is designed and put into use. When a conventional dual-heating wire atomization apparatus switches a working mode, a working heating wire is switched based on a fixed inhalation quantity, or a working heating wire is switched based on an accumulated heating amount of the heating wire. However, these switching methods can easily cause mismatches between the e-liquid and battery level. Thus, a waste of electric quantity is caused, or an aerosol-forming medium is not completely atomized, thereby reducing working performance of the atomization apparatus.

### SUMMARY

In an embodiment, the present invention provides an atomization apparatus control method for an atomization apparatus that includes at least two heating elements, the method comprising: obtaining a battery level parameter of the atomization apparatus; and if the battery level parameter is less than a preset threshold, controlling the atomization apparatus to work in a single-heating element mode in which one heating element of the includes at least two heating elements works, or if the battery level parameter is greater than or equal to the preset threshold, controlling the atomization apparatus to work in a multi-heating element mode in which the at least two heating elements work simultaneously.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic flowchart of an atomization apparatus control method according to an embodiment;

FIG. 2 is a schematic flowchart of steps of controlling an atomization apparatus to work in a single-heating element mode according to an embodiment;

FIG. 3 is a schematic flowchart of steps of controlling an atomization apparatus to work in a single-heating element mode according to another embodiment;

FIG. 4 is a schematic diagram of a time sequence for controlling heating elements to alternately work according to another embodiment;

FIG. 5 is a schematic flowchart of an atomization apparatus control method according to another embodiment;

FIG. 6 is a schematic flowchart of steps of controlling an atomization apparatus to work in a multi-heating element mode according to an embodiment;

FIG. 7 is a schematic flowchart of an atomization apparatus control method according to still another embodiment;

FIG. 8 is a schematic structural block diagram of an atomization apparatus according to an embodiment;

FIG. 9 is a schematic structural block diagram of an output control module according to an embodiment;

FIG. 10 is a schematic diagram of a circuit structure of an output control module according to an embodiment;

FIG. 11 is a schematic structural block diagram of an atomization apparatus according to another embodiment;

FIG. 12 is a detailed schematic flowchart of an atomization apparatus control method according to an embodiment; and

FIG. 13 is a detailed schematic flowchart of an atomization apparatus control method according to another embodiment.

### DETAILED DESCRIPTION

In an embodiment, the present invention provides an atomization apparatus control method and an atomization apparatus that can improve working performance of the atomization apparatus for the foregoing technical problem.

An atomization apparatus control method, where the atomization apparatus includes at least two heating elements, and the method includes:
obtaining a battery level parameter of the atomization apparatus; and
if the battery level parameter is less than a preset threshold, controlling the atomization apparatus to work in a single-heating element mode; where in the single-heating element mode, one heating element in the atomization apparatus works; or
if the battery level parameter is greater than or equal to the preset threshold, controlling the atomization apparatus to work in a multi-heating element mode; where in the multi-heating element mode, at least two heating elements in the atomization apparatus work simultaneously.

In an embodiment, the controlling the atomization apparatus to work in a single-heating element mode includes:
successively controlling, within different time periods, one heating element of the heating elements to work; where different heating elements work in different time periods; and
if total duration of working of the heating elements is greater than a preset total duration threshold, controlling the heating elements to stop working.

In an embodiment, the controlling the atomization apparatus to work in a single-heating element mode includes:
controlling the heating elements to work alternately; and
if the sum of cumulative duration of working of the heating elements is greater than a preset total duration threshold, controlling the heating elements to stop working.

In an embodiment, after the obtaining a battery level parameter of the atomization apparatus, the method further includes:
if the battery level parameter is less than a preset battery level threshold, controlling the atomization apparatus to work in a boost mode; or
if the battery level parameter is greater than or equal to the preset battery level threshold, controlling the atomization apparatus to work in a straight-through chopping mode; where a voltage provided for the heating element in the boost mode is greater than a voltage provided for the heating element in the straight-through chopping mode.

In an embodiment, the controlling the atomization apparatus to work in a multi-heating element mode includes:

controlling, at the same moment, at least two heating elements in the heating elements to work simultaneously; and

if heating start duration is greater than a preset total duration threshold, controlling the heating elements to stop working.

In an embodiment, before the obtaining a battery level parameter of the atomization apparatus, the method further includes:
determining whether a heating start signal is received; and
if yes, executing the obtaining of the battery level parameter of the atomization apparatus.

In an embodiment, the method further includes:
in a working process of the heating elements, if a heating stop signal is received, control the heating elements to stop working.

An atomization apparatus includes a power supply module, a control module, an output control module, and a heating element, where there are at least two heating elements, different heating elements are correspondingly connected to different output control modules, the power supply module and each output control module are both connected to the control module, and the control module is configured to implement the foregoing method.

In an embodiment, the output control module includes a straight-through chopper circuit and a boost circuit that are connected to the control module, and both the straight-through chopper circuit and the boost circuit are connected to the heating element;
the control module is configured to: when a battery level parameter of the atomization apparatus is less than a preset battery level threshold, control both the straight-through chopper circuit and the boost circuit to work; and
the control module is further configured to: when the battery level parameter of the atomization apparatus is greater than or equal to the preset battery level threshold, control the straight-through chopper circuit to work, and control the boost circuit to stop working.

In an embodiment, the straight-through chopper circuit includes an output switching transistor and an output circuit; and
a control terminal of the output switching transistor is connected to the control module, a first terminal of the output switching transistor is connected to the power supply module, and a second terminal of the output switching transistor is connected to the heating element through the output circuit.

In the foregoing atomization apparatus control method and atomization apparatus, the atomization apparatus includes at least two heating elements, and the method includes: obtaining a battery level parameter of the atomization apparatus; and if the battery level parameter is less than a preset threshold, controlling the atomization apparatus to work in a single-heating element mode, where in the single-heating element mode, one heating element in the atomization apparatus works; or if the battery level parameter is greater than or equal to the preset threshold, controlling the atomization apparatus to work in a multi-heating element mode, where in the multi-heating element mode, at least two heating elements in the atomization apparatus work simultaneously. The atomization apparatus is controlled to work in different modes according to the value of the battery level parameter of the atomization apparatus, so that different quantities of heating elements can work. The heating degree is matched according to the battery level parameter and thus the atomization amount is matched, which can effectively resolve the problem of mismatch between the e-liquid and battery level in a conventional dual-heating wire atomization apparatus, and working performance of the atomization apparatus is improved.

To make the objectives, technical solutions, and advantages of this application clearer, the following further describes this application in detail with reference to the accompanying drawings and the embodiments. It is to be understood that the specific embodiments described herein are only used for explaining this application, and are not used for limiting this application.

An atomization apparatus control method provided in an embodiment of this application is used to control an atomization apparatus, and may be specifically used to control a working status and a working mode of the atomization apparatus. Generally, the atomization apparatus includes a power supply module, a control module, an output control module, and a heating element. The power supply module is connected to the control module and the output control module, and is configured to supply power to the control module and the output control module. The type of the heating element is not limited, for example, may be a heating wire, a heating coil, or a heating plate. For example, the heating element in this embodiment may be a grid heating wire, and the grid heating wire is obtained by processing a stainless steel sheet into a grid shape through an etching process. There are at least two heating elements. Different heating elements are correspondingly connected to different output control modules, and one output control module is correspondingly connected to one heating element. Each heating element may be separately controlled, so that working statuses of the heating elements do not interfere with each other. Each output control module is connected to the control module, and the control module may control a working status of each output control module, so as to control a working status of a heating element connected to the output control module. For example, when the control module controls the output control module to be turned on, the heating element may work after being powered on by the output control module, and start to heat up. When the control module controls the output control module to be turned off, the heating element is powered off and stops heating up.

The atomization apparatus control method may be performed by the control module of the atomization apparatus. The control module may control the working status of the heating element by controlling the working status of the output control module, and may further control a working status of another structure. Details are not described herein. It may be understood that, in some other embodiments, the atomization apparatus control method may alternatively be performed by a terminal or a server that is communicatively connected to the atomization apparatus and may exchange data with the atomization apparatus. The terminal may be but is not limited to various personal computers, laptop computers, smartphones, tablet computers, Internet of Things devices, and portable wearable devices, and the server may be implemented by using an independent server or a server cluster including multiple servers.

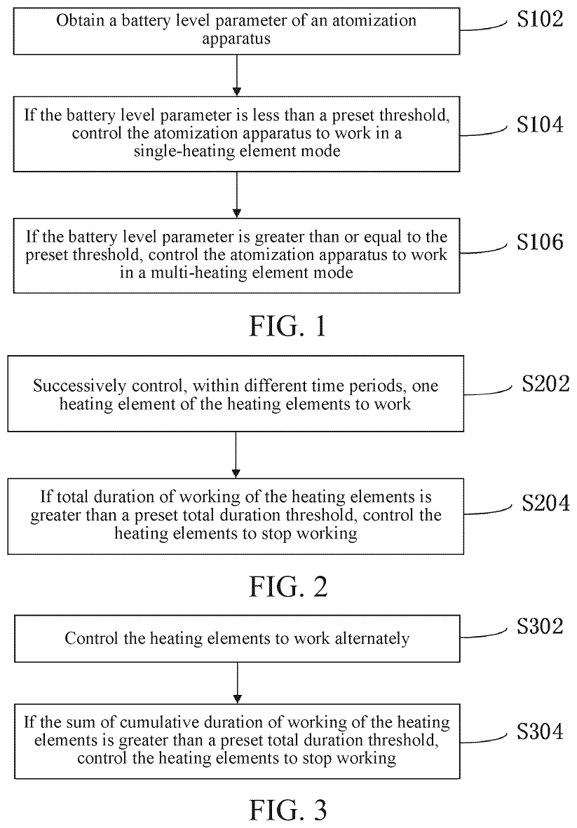

In an embodiment, as shown in FIG. 1, an atomization apparatus control method is provided. An example in which the method is performed by a control module is used for description, and the method includes the following steps:

Step 102: Obtain a battery level parameter of an atomization apparatus.

The battery level parameter is generally a battery level parameter of a power supply module of the atomization apparatus, and is used to represent a current battery level of the atomization apparatus. The battery level parameter may be a specific battery level value, or may be the percentage of the current remaining electric quantity in the rated electric quantity, which is not limited herein. For example, in this embodiment, the power supply module includes a battery, and the battery level parameter may be the percentage of the remaining electric quantity of the battery in the rated electric quantity.

Step 104: If the battery level parameter is less than a preset threshold, control the atomization apparatus to work in a single-heating element mode.

The preset threshold is used as a comparison object of the battery level parameter, and has the same type as the battery level parameter. For example, if the battery level parameter is a percentage, the preset threshold is also a percentage. The electric quantity status of the atomization apparatus may be determined according to a size relationship between the battery level parameter and the preset threshold, and the atomization apparatus is controlled accordingly to be in different working modes. The value of the preset threshold is not unique, and may be determined according to the type of the power supply module, for example, may be 60% or 70%.

If the battery level parameter is less than the preset threshold, it is considered that the current electric quantity of the atomization apparatus is insufficient. In this case, the atomization apparatus is controlled to work in the single-heating element mode, and in the single-heating clement mode, one heating element in the atomization apparatus works. In the single-heating clement mode, only one heating clement works at the same moment, and the heating intensity is relatively low, so that e-liquid and battery level matching can be better implemented. This avoids the following situation in a case of insufficient electric quantity: excessively high heating intensity causes excessively fast power consumption, resulting in that the aerosol-forming medium still cannot be completely atomized after the electric quantity is used up, resulting in a waste of resources.

E-liquid and battery level matching is an expected state, which means that, according to user needs, it is expected to match the battery electric quantity with the quantity of the aerosol-forming medium, that is, when the battery electric quantity is used up, the aerosol-forming medium is also used up.

Step 106: If the battery level parameter is greater than or equal to the preset threshold, control the atomization apparatus to work in a multi-heating element mode.

If the battery level parameter is greater than or equal to the preset threshold, it is considered that the current electric quantity of the atomization apparatus is sufficient, in this case, the atomization apparatus is controlled to work in the multi-heating element mode, and in the multi-heating element mode, at least two heating elements in the atomization apparatus work simultaneously. In the multi-heating element mode, at least two heating elements work simultaneously at the same moment. Further, working heating elements are heating elements connected to different output control modules. The quantity of working heating elements may be determined according to actual needs. For example, if the atomization apparatus includes two heating elements, the quantity of heating elements working in the multi-heating element mode is two. If the atomization apparatus includes three heating elements, the quantity of heating elements working in the multi-heating element mode may be two or three. It may be understood that the quantity of heating elements working in the multi-heating element mode is not unique, and may be determined according to actual needs.

If the battery level parameter is greater than or equal to the preset threshold, the atomization apparatus is controlled to work in the multi-heating element mode. In this case, the electric quantity is sufficient, and heating intensity is relatively high, so that e-liquid and battery level matching can be better implemented. This avoids the following situation in a case of sufficient electric quantity: excessively low heating intensity causes excessively slow power consumption, resulting in that the aerosol-forming medium has been completely atomized before the electric quantity is used up, resulting in a waste of electric quantity.

In the foregoing atomization apparatus control method, the atomization apparatus includes at least two heating elements, and the method includes: obtaining a battery level parameter of the atomization apparatus; and if the battery level parameter is less than a preset threshold, controlling the atomization apparatus to work in a single-heating element mode, where in the single-heating element mode, one heating element in the atomization apparatus works; or if the battery level parameter is greater than or equal to the preset threshold, controlling the atomization apparatus to work in a multi-heating element mode, where in the multi-heating element mode, at least two heating elements in the atomization apparatus work simultaneously. The atomization apparatus is controlled to work in different modes according to the value of the battery level parameter of the atomization apparatus, so that different quantities of heating elements can work. The heating degree is matched according to the battery level parameter and thus the atomization amount is matched, which can effectively resolve the problem of mismatch between the e-liquid and battery level in a conventional dual-heating wire atomization apparatus, and working performance of the atomization apparatus is improved.

In an embodiment, as shown in FIG. 2, in step 104, the step of controlling the atomization apparatus to work in the single-heating element mode includes step 202 and step 204.

Step 202: Successively control, within different time periods, one heating element of the heating elements to work.

Heating elements working in different time periods are different. Duration of different time periods may be the same or may be different, and may be determined according to an actual situation. The specific duration of the time period may be stored in the control module as a preset value after being determined according to experiments, or may be flexibly adjusted according to a received user instruction.

For example, the quantity of heating elements is two, including a heating element 1 and a heating element 2, and the quantity of output control modules is two, including an output control module 1 and an output control module 2, where the output control module 1 is connected to the heating element 1, and the output control module 2 is connected to the heating element 2. If the battery level parameter is less than the preset threshold, the atomization apparatus is controlled to work in the single-heating element mode. In different time periods, one heating element of the heating elements is successively controlled to work. Then, in the first time period (for example, 5 ms), the control module first controls the output control module 1 connected to the heating element 1 to output, so that the heating element 1 works, and obtains working duration Ta of the heating element 1. After the working duration Ta of the heating element 1 reaches the duration of the first time period, within the second time period (for example, 5 ms), the control module further controls the output control module 2 connected to the heating element 2 to output, so that the heating element 2 works, obtains working duration Tb of the heating element 2, and the heating element 2 stops working after the working duration Tb of the heating element 2 reaches the duration of the second time period.

Step 204: If total duration of working of the heating elements is greater than a preset total duration threshold, controlling the heating elements to stop working.

The preset total duration threshold is used to represent expected heating duration, and may be determined according to experiments or experience, or may be flexibly adjusted according to a received user instruction. For example, in this embodiment, the preset total duration threshold is 8 s.

In the working process of each heating element, the control module records working duration of each heating element, and adds each working duration to obtain the total working duration of the heating elements. If the total working duration of the heating elements is longer than the preset total duration threshold, it is considered that the working duration has met needs, and the heating elements are controlled to stop working.

In this embodiment, in different time periods, one heating element of the heating elements is successively controlled to work, and different heating elements are controlled in turn to work in different time periods until the total working duration of the heating elements is greater than the preset total duration threshold, so that the heating elements are controlled to stop working. Each time one heating element is controlled to work, heating intensity can be effectively limited. When the total working duration of the heating elements is greater than the preset total duration threshold, it is considered that the atomization apparatus has completed a target work task, and the heating elements are controlled to stop working, thereby avoiding a waste of resources.

In an embodiment, as shown in FIG. 3, in step 104, the step of controlling the atomization apparatus to work in the single-heating element mode includes step 302 and step 304.

Step 302: Control the heating elements to work alternately.

Alternate working of the heating elements means that the heating elements work in different time periods, and a working time period of one heating element includes time periods not adjacent to each other.

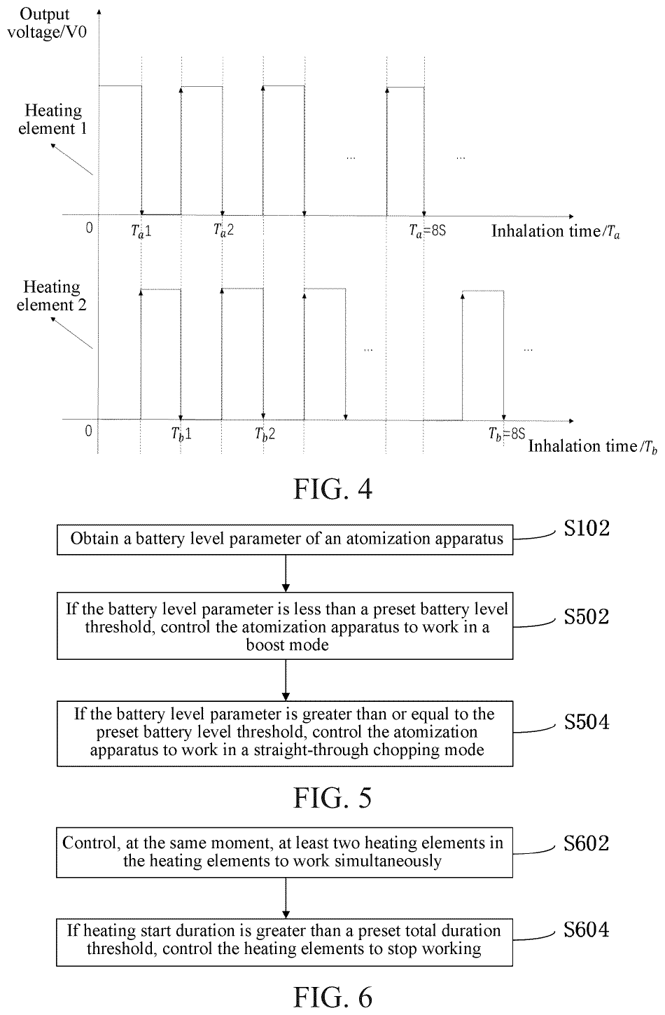

For example, the quantity of heating elements is two, including a heating element 1 and a heating element 2, and the quantity of output control modules is two, including an output control module 1 and an output control module 2, where the output control module 1 is connected to the heating element 1, and the output control module 2 is connected to the heating element 2. If the battery level parameter is less than the preset threshold, the atomization apparatus is controlled to work in the single-heating element mode, and the heating elements are controlled to work alternately. As shown in FIG. 4, in the first sub time period Ta1 of the heating element 1, the control module first controls the output control module 1 connected to the heating element 1 to output, so that the heating element 1 works. Then, in the first sub time period Tb1 of the heating element 2, the control module controls the output control module 2 connected to the heating element 2 to output, so that the heating element 2 works.

Then, in the second sub time period Ta2 of the heating element 1, the control module controls the output control module 1 connected to the heating element 1 to output, so that the heating element 1 works. Then, in the second sub time period Tb2 of the heating element 2, the control module controls the output control module 2 connected to the heating element 2 to output, so that the heating element 2 works, and so on. According to the time axis sequence, there are the first sub time period of the heating element 1, the first sub time period of the heating element 2, the second sub time period of the heating element 1, and the second sub time period of the heating element 2 successively, and so on.

Step 304: If the sum of cumulative duration of working of the heating elements is greater than a preset total duration threshold, control the heating elements to stop working.

The cumulative duration of working of the heating elements is the sum of different sub time periods of working of the heating elements, and the cumulative duration of working of the heating elements is summated to obtain the sum of the cumulative duration of working of the heating elements. The preset total duration threshold is used to represent expected heating duration, and may be determined according to experiments or experience, or may be flexibly adjusted according to a received user instruction. For example, in this embodiment, the preset total duration threshold is 8 s.

In the working process of each heating element, the control module records duration of each sub time period of working of each heating element, adds the duration of each sub time period, and then adds duration of each sub time period corresponding to each heating element to obtain the sum of the cumulative duration of working of the heating elements. If the sum of the cumulative duration of working of the heating elements is greater than the preset total duration threshold, it is considered that the working duration has met needs, and the heating elements are controlled to stop working.

In this embodiment, the heating elements are controlled to work alternately. If the sum of the cumulative duration of working of the heating elements is greater than the preset total duration threshold, the heating elements are controlled to stop working. Controlling the heating elements to work alternately can avoid an abnormal case in which an excessively high temperature is caused by excessively long heating duration of the heating elements. If the sum of the cumulative duration of working of the heating elements is greater than the preset total duration threshold, it is considered that the atomization apparatus has completed a target work task, and the heating elements are controlled to stop working, thereby avoiding a waste of resources.

In an embodiment, as shown in FIG. 5, after step 102, the atomization apparatus control method further includes step 502 and step 504.

Step 502: If the battery level parameter is less than a preset battery level threshold, control the atomization apparatus to work in a boost mode.

If the battery level parameter is less than the preset battery level threshold, it is considered that the current electric quantity is relatively low, and the power of the heating element may be too low. In this case, the atomization apparatus is controlled to work in the boost mode, so as to increase the working power of the heating element, so as to avoid that the power of the heating clement drops too fast.

The preset battery level threshold may be equal to the preset threshold. In this case, if the battery level parameter is less than the preset battery level threshold, there is a high probability that the atomization apparatus will work in the single-heating element mode. The heating power in the single-heating element mode is relatively low. In this case, the atomization apparatus is controlled to work in the boost mode, and working power of the heating element is increased in a boost manner, which can effectively resolve the problem of inhalation interruption caused by a switching delay in the single-heating element working mode.

The preset battery level threshold may be further greater than the preset threshold. In this case, if the battery level parameter is greater than the preset threshold and is less than the preset battery level threshold, the control module controls the atomization apparatus to work in a dual-heating clement mode. In this case, the atomization apparatus is controlled to work in the boost mode, and the working power of the heating element is increased in the boost manner, which can effectively resolve the problem of severe mouthfeel attenuation during inhalation in the case of low electric quantity, and the problem of a prolonged switching gap when working of the heating clement is switched.

The manner of controlling the atomization apparatus to work in the boost mode is not unique. For example, a boost circuit is arranged in the atomization apparatus, the boost circuit is connected to the heating element and the control module, and the control module can control the atomization apparatus to work in the boost mode by controlling the boost circuit to work.

It may be understood that, in other embodiments, the atomization apparatus may alternatively be controlled to work in the boost mode according to a detected signal. For example, when a boost instruction sent by a user is received, it is considered that the user wants to increase the heating power in this case, the control module may also control the atomization apparatus to work in the boost mode, increase the heating power, increase the atomization amount or the atomization rate, and the like, so as to meet user needs.

Step 504: If the battery level parameter is greater than or equal to the preset battery level threshold, control the atomization apparatus to work in a straight-through chopping mode.

The straight-through chopping mode refers to a working mode in which the atomization apparatus converts, according to a control signal of the control module, an accessed power supply voltage into a voltage corresponding to the control signal. A voltage provided for the heating element in the boost mode is greater than a voltage provided for the heating element in the straight-through chopping mode. Generally, the power of the heating element in the boost mode is greater than the power of the heating element in the straight-through chopping mode.

If the battery level parameter is greater than or equal to the preset battery level threshold, it is considered that the current electric quantity is relatively high, and no further boost may be performed on the heating element. In this case, the atomization apparatus is controlled to work in the straight-through chopping mode, so that the atomization apparatus can work according to a default working procedure or user needs.

The manner of controlling the atomization apparatus to work in the straight-through chopping mode is not unique. For example, a straight-through chopper circuit is arranged in the atomization apparatus, the straight-through chopper circuit is connected to the heating element and the control module, and the control module may control the atomization apparatus to work in the straight-through chopping mode by controlling the working status of the straight-through chopper circuit.

In this embodiment, the atomization apparatus is controlled to work in different modes according to a size relationship between the battery level parameter and the preset battery level threshold, so that working performance of the atomization apparatus can be fully ensured. When the battery level parameter is greater than or equal to the preset battery level threshold, the atomization apparatus is controlled to work in the straight-through chopping mode to implement on-demand working. When the battery level parameter is less than the preset battery level threshold, the atomization apparatus is controlled to work in the boost mode, which is conducive to the problem of inhalation interruption caused by the switching delay in the single-heating element mode, and the problems of mouthfeel attenuation and a prolonged switching delay of a single heating element when the battery electric quantity is relatively low in the dual-heating element mode, which can improve atomization quality of the atomization apparatus and better meet user needs.

In an embodiment, as shown in FIG. 6, in step 106, the step of controlling the atomization apparatus to work in the multi-heating element mode includes step 602 and step 604.

Step 602: Control, at the same moment, at least two heating elements in the heating elements to work simultaneously.

At the same moment, at least two heating elements of the heating elements are controlled to work simultaneously. Further, working heating elements include heating elements connected to different output control modules. The quantity of working heating elements may be determined according to actual needs. For example, if the atomization apparatus includes two heating elements, the quantity of heating elements working in the multi-heating element mode is two. If the atomization apparatus includes three heating elements, the quantity of heating elements working in the multi-heating element mode may be two or three. It may be understood that the quantity of heating elements working in the multi-heating element mode is not unique, and may be determined according to actual needs.

Step 604: If heating start duration is greater than a preset total duration threshold, control the heating elements to stop working.

The heating start duration refers to duration from a heating start moment to a current timing moment. The preset total duration threshold is used to represent expected heating duration, and may be determined according to experiments or experience, or may be flexibly adjusted according to a received user instruction. For example, in this embodiment, the preset total duration threshold is 8 s.

In the working process of each heating element, the control module records the heating start duration, compares the heating start duration with the preset total duration threshold, if the heating start duration is greater than the preset total duration threshold, considers that the working duration meets needs, and controls each heating element to stop working.

In this embodiment, at the same moment, at least two heating elements of the heating elements are controlled to work simultaneously, and a relatively large quantity of electric quantity is matched by relatively large consumption of the aerosol-forming medium, so as to facilitate e-liquid and battery level matching until the heating start duration is greater than the preset total duration threshold. Then, it is considered that the atomization apparatus has completed a target work task, each heating element is controlled to stop working, thereby avoiding a waste of resources.

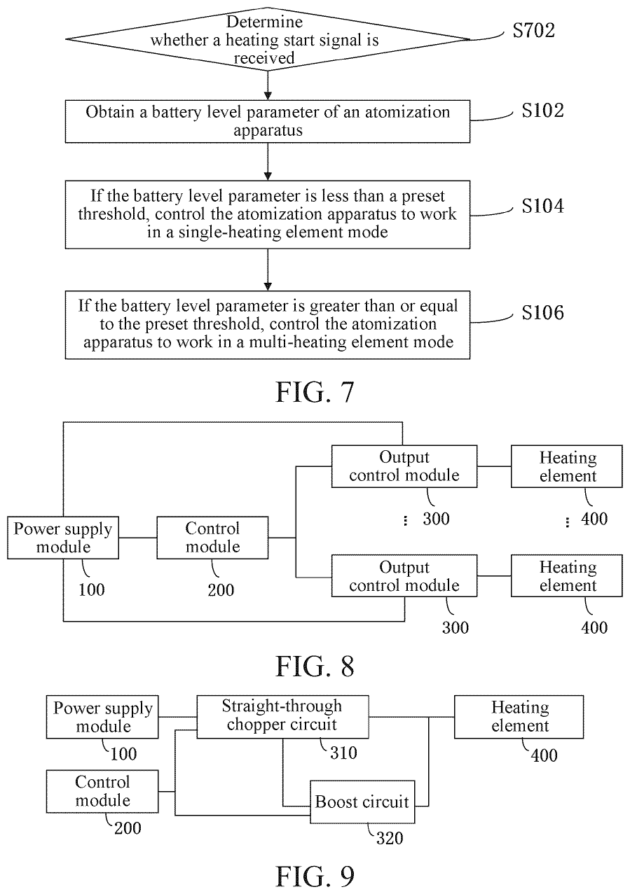

In an embodiment, as shown in FIG. 7, before step 102, the atomization apparatus control method further includes step 701.

Step 701: Determine whether a heating start signal is received.

If yes, step 102 is performed. The heating start signal is used to represent a heating need. If the heating start signal is received, it is considered that the user has a heating need for the atomization apparatus in this case, and a subsequent step may be performed to further control and optimize the working process of the atomization apparatus.

The type of the heating start signal is not unique. For example, the heating start signal may be a start signal sent by the user by using an information exchange module. The information exchange module is connected to the control module, and the type of the information exchange module is not limited. For example, the information exchange module may be a key or a touchscreen. For example, the information exchange module is a key. If the user presses the key and the control module receives a signal that the key is pressed, it is considered that a heating start signal is received.

Or the heating start signal may be an inhalation signal. The inhalation signal may be detected by using an airflow sensor, and then transmitted to the control module. The airflow sensor may be arranged in an inhalation channel of the atomization apparatus. For example, when the user has an inhalation action on the atomization apparatus, the airflow sensor detects an inhalation signal, and sends the inhalation signal to the control module. After receiving the inhalation signal, the control module may consider that a heating start signal is received.

In this embodiment, after the heating start signal is received, a subsequent control step is performed, so that the atomization apparatus can be started on demand.

In an embodiment, the atomization apparatus control method further includes the following step: In a working process of the heating elements, if a heating stop signal is received, Control the heating elements to stop working.

The heating stop signal is used to represent a heating stop need. The type of the heating stop signal is not unique, for example, may be a signal opposite to the heating start signal. For example, the heating stop signal may be a start signal sent by the user by using the information exchange module. The information exchange module is connected to the control module, and the type of the information exchange module is not limited. For example, the information exchange module may be a key or a touchscreen. For example, the information exchange module is a key. If the user releases the key, and the control module receives a signal that the key is released, it is considered that a heating stop signal is received.

For example, the heating start signal may alternatively be an inhalation signal. The inhalation signal may be detected by using an airflow sensor, and then transmitted to the control module. The airflow sensor may be arranged in an inhalation channel of the atomization apparatus. For example, when the user stops the inhalation action on the atomization apparatus, the airflow sensor cannot detect the inhalation signal. If the control module does not receive the inhalation signal transmitted by the airflow sensor, it may be considered that a heating stop signal is received.

In this embodiment, in the working process of the heating clement, if a heating stop signal is received, it is considered that in this case, the atomization apparatus is not required to heat up, each heating element is controlled to stop working, and the atomization apparatus is controlled in time to stop heating up, so as to meet needs, and a waste of resources can also be reduced.

In the foregoing atomization apparatus control method, the atomization apparatus includes at least two heating elements, and the method includes: obtaining a battery level parameter of the atomization apparatus; and if the battery level parameter is less than a preset threshold, controlling the atomization apparatus to work in a single-heating element mode, where in the single-heating element mode, one heating element in the atomization apparatus works; or if the battery level parameter is greater than or equal to the preset threshold, controlling the atomization apparatus to work in a multi-heating element mode, where in the multi-heating element mode, at least two heating elements in the atomization apparatus work simultaneously. The atomization apparatus is controlled to work in different modes according to the value of the battery level parameter of the atomization apparatus, so that different quantities of heating elements can work. The heating degree is matched according to the battery level parameter and thus the atomization amount is matched, which can effectively resolve the problem of mismatch between the e-liquid and battery level in a conventional dual-heating wire atomization apparatus, and working performance of the atomization apparatus is improved.

In an embodiment, an atomization apparatus is provided. As shown in FIG. 8, the atomization apparatus includes a power supply module 100, a control module 200, an output control module 300, and a heating element 400. There are at least two heating elements 400. Different heating elements 400 are correspondingly connected to different output control modules 300, and both the power supply module 100 and each output control module 300 are connected to the control module 200. The control module 200 is configured to implement the method in any one of the foregoing embodiments.

The power supply module 100 is connected to the control module 200 and the output control module 300, and is configured to supply power to the control module 200 and the output control module 300. The type of the heating element 400 is not limited, for example, may be a heating wire, a heating coil, or a heating plate. For example, the heating element 400 in this embodiment may be a grid heating wire, and the grid heating wire is obtained by processing a stainless steel sheet into a grid shape through an etching process. There are at least two heating elements 400. Different heating elements 400 are correspondingly connected to different output control modules 300, and one output control module 300 is correspondingly connected to one heating element 400. Each heating element 400 may be separately controlled, so that working statuses of the heating elements 400 do not interfere with each other. Each output control module 300 is connected to the control module 200, and the control module 200 may control a working status of each output control module 300, so as to control a working status of a heating element 400 connected to the output control module 300. For example, when the control module 200 controls the output control module 300 to be turned on, the heating element 400 may work after being powered on by the output control module 300, and start to heat up. When the control module 200 controls the output control module 300 to be turned off, the heating element 400 is powered off and stops heating up.

In an embodiment, as shown in FIG. 9, the output control module 300 includes a straight-through chopper circuit 310 and a boost circuit 320 that are connected to the control module 200, and both the straight-through chopper circuit 310 and the boost circuit 320 are connected to the heating element 400. The control module 200 is configured to: when a battery level parameter of the atomization apparatus is less than a preset battery level threshold, control both the straight-through chopper circuit 310 and the boost circuit 320 to work. The control module 200 is further configured to: when the battery level parameter of the atomization apparatus is greater than or equal to the preset battery level threshold, control the straight-through chopper circuit 310 to work, and control the boost circuit 320 to stop working.

Specifically, When the battery level parameter of the atomization apparatus is less than the preset battery level threshold, the control module 200 controls both the straight-through chopper circuit 310 and the boost circuit 320 to work, and the voltage obtained after boosting by the boost circuit 320 is transmitted to the heating element 400 by using the straight-through chopper circuit 310, thereby boosting the voltage. If the battery level parameter is less than the preset battery level threshold, it is considered that the current electric quantity is relatively low, and the power of the heating element 400 may be too low. In this case, both the straight-through chopper circuit 310 and the boost circuit 320 are controlled to work, so that the atomization apparatus works in a boost mode, working power of the heating element 400 is increased, and the power of the heating element 400 is prevented from falling too fast.

The control module 200 is further configured to: when the battery level parameter of the atomization apparatus is greater than or equal to the preset battery level threshold, control the straight-through chopper circuit 310 to work, and control the boost circuit 320 to stop working. Until the chopper circuit converts, according to a control signal of the control module 200, an accessed power supply voltage into a voltage corresponding to the control signal, and then make the voltage act on the heating element 400. If the battery level parameter is greater than or equal to the preset battery level threshold, it is considered that the current electric quantity is relatively high, and no further boost may be performed on the heating element 400. In this case, the straight-through chopper circuit 310 is controlled to work, and the boost circuit 320 is controlled to stop working, so that the atomization apparatus works in a straight-through chopping mode, and the atomization apparatus can work according to a default working procedure or user needs.

In this embodiment, the straight-through chopper circuit 310 and the boost circuit 320 are controlled according to a size relationship between the battery level parameter and the preset battery level threshold, so that the atomization apparatus works in different modes, which can fully ensure working performance of the atomization apparatus and better meet user needs.

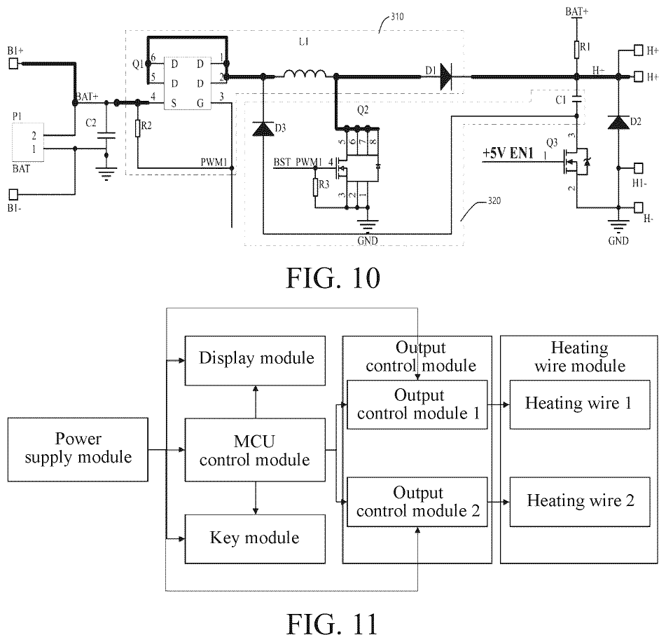

In an embodiment, as shown in FIG. 10, the straight-through chopper circuit 310 includes an output switching transistor Q1 and an output circuit. A control terminal of the output switching transistor Q1 is connected to the control module 200, a first terminal of the output switching transistor Q1 is connected to the power supply module 100, and a second terminal of the output switching transistor Q1 is connected to the heating element 400 through the output circuit. In the figure, terminals B+ and B− are connected to the power supply module, and terminals H+ and H− are respectively connected to two terminals of a heating element.

The control module 200 may send a control signal to the control terminal of the output switching transistor Q1, and the control signal may be a PWM wave signal, so as to control an on/off state of the output switching transistor Q1. When the output switching transistor Q1 is on, electric energy of a power supply connected to the first terminal of the output switching transistor Q1 passes through the first switching transistor, and is transmitted to the heating element 400 through the output circuit, so that the heating element 400 is powered on to work. In this case, the atomization apparatus works in the straight-through chopping mode.

Specifically, the structure of the output circuit is not unique. For example, the output circuit includes an output inductor L1 and an output diode D1, one terminal of the output inductor L1 is connected to the second terminal of the output switching transistor Q1, the other terminal of the output inductor L1 is connected to the anode of the output diode D1, and the cathode of the output diode D1 is connected to the heating element 400. When the output switching transistor Q1 is on, the electric energy of the power supply connected to the first terminal of the output switching transistor Q1 passes through the first switching transistor, and then reaches the output inductor L1. After the action by the inductor, the electric energy is transmitted to the heating element 400 through the output diode D1, so that the heating element 400 is powered on to work. It may be understood that, in some other embodiments, the structures of the output circuit and the straight-through chopper circuit 310 may alternatively be other structures, provided that a person skilled in the art considers that they can be implemented.

In this embodiment, the straight-through chopper circuit 310 includes the output switching transistor Q1 and the output circuit. The control terminal of the output switching transistor Q1 is connected to the control module 200, the first terminal of the output switching transistor Q1 is connected to the power supply module 100, and the second terminal of the output switching transistor Q1 is connected to the heating element 400 through the output circuit. The control module 200 may control the working status of the heating element 400 by controlling the on state of the output switching transistor Q1, so as to control working of the atomization apparatus, for example, control the atomization apparatus whether to work in the straight-through chopping mode.

In an embodiment, as shown in FIG. 10, the boost circuit 320 includes a boost control switching transistor Q2, a boost capacitor C1, and a boost diode D3. The cathode of the boost diode D3 is connected to the first terminal of the output circuit, the anode of the boost diode D3 is connected to a first terminal of the boost capacitor C1, a second terminal of the boost capacitor C1 is connected to the second terminal of the output circuit, a control terminal of the boost control switching transistor Q2 is connected to the control module 200, a first terminal of the boost control switching transistor Q2 is connected to the output circuit, and a second terminal of the boost control switching transistor Q2 is grounded.

The control module 200 may send a control signal to the control terminal of the boost control switching transistor Q2, where the control signal may be a PWM wave signal, to control an on/off state of the boost control switching transistor Q2. When the boost control switching transistor Q2 is on, the output circuit is grounded, the boost capacitor C1 and the boost diode D3 are not in use, and the atomization apparatus may work in the straight-through chopping mode. When the boost control switching transistor Q2 is off, the boost capacitor C1, the boost diode D3, and the output circuit form a loop, so as to boost the voltage. The atomization apparatus may work in the boost mode.

Further, for example, the output circuit includes the output inductor L1 and the output diode D1. The first terminal of the output circuit refers to a common terminal between the output inductor L1 and the output switching transistor Q1, and is connected to the cathode of the boost diode D3. The second terminal of the output circuit refers to the cathode of the output diode D1, and is connected to the second terminal of the boost capacitor C1. That the first terminal of the boost control switching transistor Q2 is connected to the output circuit means that the first terminal of the boost control switching transistor Q2 is connected to the common terminal of the output circuit, and the common terminal of the output circuit is a common terminal of two components in the output circuit, that is, the common terminal of the output inductor L1 and the output diode D1.

In this embodiment, the boost circuit 320 includes the boost control switching transistor Q2, the boost capacitor C1, and the boost diode D3. The cathode of the boost diode D3 is connected to the first terminal of the output circuit, the anode of the boost diode D3 is connected to a first terminal of the boost capacitor C1, a second terminal of the boost capacitor C1 is connected to the second terminal of the output circuit, a control terminal of the boost control switching transistor Q2 is connected to the control module 200, a first terminal of the boost control switching transistor Q2 is connected to the output circuit, and a second terminal of the boost control switching transistor Q2 is grounded. The control module 200 may control the boost circuit 320 whether to implement the boost function by controlling the on state of the boost control switching transistor Q2, so as to control the atomization apparatus whether to work in the boost mode.

In an embodiment, the atomization apparatus further includes a display module connected to the control module 200, and each display module is respectively connected to a different heating element 400. Working statuses of different heating elements 400 during work may be displayed by using different display modules, and a display effect is intuitive.

Specifically, the type of the display module is not unique, for example, may be a display lamp. The electric quantity of the display lamp may be used to prompt the remaining electric quantity and working time during working of a corresponding heating element 400, so that the user better monitors the working status of the atomization apparatus. It may be understood that, in some other embodiments, the type and function of the display module may be other types and functions, provided that a person skilled in the art considers that they can be implemented.

To better understand the foregoing embodiments, the following provides detailed explanations and descriptions with reference to a specific embodiment. An existing dual-heating wire control technology is not mature and stable. In a long-term dual-heating wire working mode, e-liquid and battery level mismatch is easily caused. A working effect of switching between heating wires based on a fixed quantity of inhalation times in a single-heating wire mode is not ideal. The heating wire is switched to work based on the accumulated heating amount of the heating wire, there is a gap or a delay at the moment of switching the heating wire to work, which easily causes inhalation interruption and poor user experience. In addition, none of existing dual-heating wire control solutions supports a boost solution, which causes severe mouthfeel attenuation during inhalation in the case of low electric quantity, and a prolonged switching gap of dual-heating wire control in the single-heating wire mode. To solve the foregoing problems, this application provides an atomization apparatus control method and an atomization apparatus, so as to resolve the problem of e-liquid and battery level matching in a dual-heating wire mode in a dual-heating wire control solution, the problem of a delay in switching between heating wires in a single-heating wire mode, and the problem of an output working mode of the heating wire, so as to improve an inhalation mouthfeel and user experience effect.

In an embodiment, as shown in FIG. 11, the atomization apparatus includes a power supply module, a control module, an output control module, heating elements, an information exchange module, and a display module, where the control module is an MCU control module, the information exchange module is a key module, the output control module includes an output control module 1 and an output control module 2, and the heating elements are heating wires, including a heating wire 1 and a heating wire 2.

The power supply module is configured to supply power to the entire circuit and provide enough electric energy to the output control module. The MCU control module is configured to receive an external instruction and an execution processing instruction. The display module is configured to display prompts such as a single-/dual-heating wire mode switching prompt, an inhalation effect prompt, and an electric quantity prompt. The key module is configured to obtain another operation instruction such as an external output control instruction and a single/dual-heating wire mode switching instruction. The output control module is configured to execute an output control instruction to adjust an output solution and obtain the resistance value of the heating wire. A heating wire module is a mesh resistance wire, and is configured to heat and atomize an aerosol-forming medium in oil storage cotton.

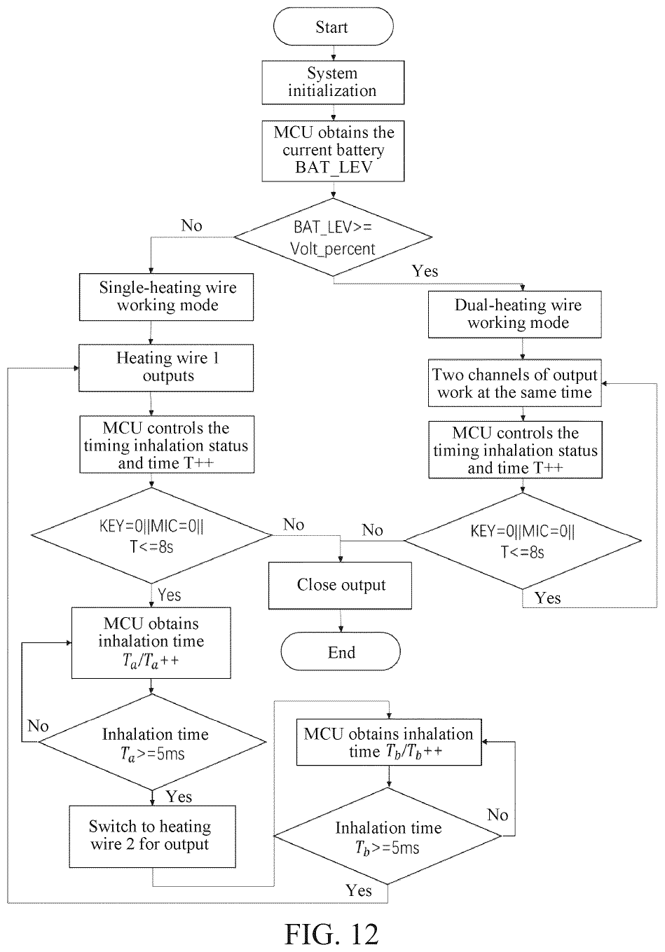

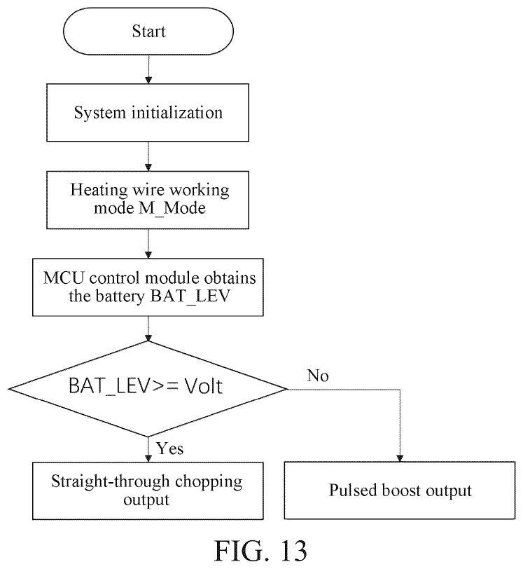

As shown in FIG. 12, the process of the atomization apparatus control method includes the following steps: First, the key module or an external switch (an airflow sensor or the like) obtains an external operation instruction. After obtaining the external operation instruction, the MCU control module 200 starts processing information and internal related detection. If it is determined that the key is in a long-press state KEY=1 or the mic is in an inhalation state MIC=1, and it is detected that the battery level parameter BAT_LEV of the internal battery is less than the preset threshold Volt_percent, the atomization apparatus is controlled to work in the single-heating element mode, which may be specifically the single-heating wire mode. M_Mode=1 is assigned, and an output control instruction and an output timing instruction T++ are executed. The MCU control module 200 adjusts the output control module 1 and the heating wire 1 to output, and output time of the output control module 1 and the heating wire 1 is Ta++. When the output time Ta of the output control module 1 and the heating wire 1 is greater than or equal to 5 ms, Ta is reset. Thereafter, the MCU control module 200 adjusts the output control module 2 and the heating wire 2 to output, and output time of the output control module 2 and the heating wire 2 is Tb++. When the output time Tb of the output control module 2 and the heating wire 2 is greater than 5 ms, Tb is reset. In addition, the display module (8 white LEDs, LED1-LED4 corresponding to the heating wire 1, and LED5-LED8 corresponding to the heating wire 2) gives a breathing prompt alternately based on an electric quantity state by using LEDs corresponding to the heating wire, so as to indicate the inhalation status. The MCU control module 200 controls its output in this cycle. When the key state is KEY=0 or the mic inhalation state is MIC=0 or the total inhalation time is T=8 S (inhalation timeout), the MCU control module 200 exits the output cycle procedure and closes the output, and the LED display module is closed.

If it is determined that the battery level parameter BAT_LEV of the current battery is greater than or equal to the preset threshold Volt_percent, the MCU control module 200 controls the atomization apparatus to jump to the multi-heating element mode, which may be specifically a dual-heating wire working mode. M_Mode=2 is assigned. The MCU control module 200 simultaneously controls the two output control modules 300 and the two heating wires to work simultaneously. Two groups of LEDs corresponding to two heating wires of the LED display module give a breathing flash prompt and output using the battery level. When the key state is KEY=0 or the mic inhalation state is MIC=0 or the total inhalation time is T=8 S (inhalation timeout), output is closed, and the LED display module is closed. The Volt_percent may be a voltage percentage, and is set to 70%. In actual design, the Volt_percent may be set according to cell type selection.

As shown in FIG. 10, the output control module 300 includes a straight-through chopper circuit 310 connected to the control module 200, and a boost circuit 320, the straight-through chopper circuit 310 includes an output switching transistor Q1 and an output circuit, and the output circuit includes an output inductor L1 and an output diode D1. The boost circuit 320 includes a boost control switching transistor Q2, a boost capacitor C1, and a boost diode D3. The output switching transistor Q1 is a PMOS transistor, and the boost control switching transistor Q2 is an NMOS transistor.

When the atomization apparatus works in the straight-through chopping mode, it outputs through straight-through chopping, and the MCU control module 200 outputs a PWM waveform to control the gate of the output switching transistor Q1 to output a required voltage. In this case, the boost function is turned off, that is, the MCU controls the gate of the boost control switching transistor Q2 to continuously output a high level BST_PWM=1, and the boost control switching transistor Q2 is turned on. When voltage boost is required, the MCU controls the gate of the output switching transistor Q1 to continuously output a low level PWM=0, and the output switching transistor Q1 is turned on. The MCU control module 200 controls the gate of the boost control switching transistor Q2 to output the PWM waveform according to the boost voltage requirement, and implements the boost function when the boost control switching transistor Q2 is disconnected.

In addition, as shown in FIG. 13, the atomization apparatus control method may further include: After the system is initialized and the working mode of the heating wire is determined, the battery level parameter is obtained, and if the battery level parameter is less than the preset battery level threshold Volt, the atomization apparatus is controlled to work in the boost mode with pulsed boost output. If the battery level parameter is greater than or equal to the preset battery level threshold Volt, the atomization apparatus is controlled to work in the straight-through chopping mode with straight-through chopping output.

It is to be understood that, although the steps are displayed sequentially according to the instructions of the arrows in the flowcharts of the embodiments, these steps are not necessarily performed sequentially according to the sequence instructed by the arrows. Unless otherwise explicitly specified in this specification, execution of the steps is not strictly limited, and the steps may be performed in other sequences. Moreover, at least some of the steps in the flowcharts in each embodiment may include a plurality of steps or a plurality of stages. The steps or stages are not necessarily performed at the same moment but may be performed at different moments. Execution of the steps or stages is not necessarily sequentially performed, but may be performed alternately with other steps or at least some of steps or stages of other steps.

In the atomization apparatus and the atomization apparatus control method provided in this application, the single-/dual-heating wire working mode is switched based on the current battery level parameter of the battery, the switching logic of two heating wires in the inhalation process is evenly controlled in the manner of refining the inhalation time, the boost mode is supported, and the output power is increased. Based on the output working mode switching logic and determining of the single/dual heating wires, and the control logic and the circuit connection relationship of the output control module, the problems of carbon deposition in a long-term working process, a reduced liquid permeation quantity, and a short working life of the single-heating wire control solution can be better resolved, the e-liquid and battery level matching problem of the existing dual-heating wire control solution can be better resolved, the switching delay problem of the existing dual-heating wire control solution in the single-heating wire working mode can be better resolved, and real balanced control output can be achieved. The mouthfeel attenuation problem in the case of low electric quantity and the problem of a prolonged switching delay of a single heating wire in the existing dual-heating wire control solution can be resolved, and the problem that the existing dual-heating wire control solution does not provide an obvious switching prompt for the two heating wire working modes can be resolved, thereby comprehensively improving working reliability of the atomization apparatus.

A person of ordinary skill in the art may understand that all or some of procedures of the method in the foregoing embodiments may be implemented by a computer program instructing relevant hardware. The program may be stored in a non-volatile computer-readable storage medium. When the program is executed, the procedures of the foregoing method embodiments may be implemented. Any reference to a memory, a storage, a database, or another medium used in the embodiments provided in this application may include at least one of a non-volatile memory and a volatile memory. The non-volatile memory may include a read-only memory (Read-Only Memory, ROM), a magnetic tape, a floppy disk, a flash memory, an optical memory, a high-density embedded non-volatile memory, a resistive random access memory (ReRAM), a magnetoresistive random access memory (Magnetoresistive Random Access Memory, MRAM), a ferroelectric random access memory (Ferroelectric Random Access Memory, FRAM), a phase change memory (Phase Change Memory, PCM), a graphene memory, and the like. The volatile memory may include a random access memory (RAM) or an external cache. For the purpose of description instead of limitation, the RAM is available in a plurality of forms, such as a static RAM (SRAM) or a dynamic RAM (DRAM). The databases involved in the embodiments provided in this application may include at least one of a relational database and a non-relational database. The non-relational database may include a blockchain based distributed database or the like, and is not limited thereto. The processor in the embodiments provided in this application may be a general purpose processor, a central processing unit, a graphics processing unit, a digital signal processor, a programmable logic device, a quantum computing-based data processing logic device, or the like, and is not limited thereto.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An atomization apparatus control method for an atomization apparatus that includes at least two heating elements, the method comprising:
obtaining a battery level parameter of the atomization apparatus; and
if the battery level parameter is less than a preset threshold, controlling the atomization apparatus to work in a single-heating element mode in which one heating element of the includes at least two heating elements works, or
if the battery level parameter is greater than or equal to the preset threshold, controlling the atomization apparatus to work in a multi-heating element mode in which the at least two heating elements work simultaneously.

2. The method of claim 1, wherein controlling the atomization apparatus to work in the single-heating element mode comprises:
successively controlling, within different time periods, one heating element of the at least one heating elements to work, different heating elements of the at least two heating elements working in different time periods; and
if a total duration of working of the different heating elements is greater than a preset total duration threshold, controlling the different heating elements to stop working.

3. The method of claim 1, wherein controlling the atomization apparatus to work in the single-heating element mode comprises:
controlling the at least two heating elements to work alternately; and
if a sum of a cumulative duration of working of the at least two heating elements is greater than a preset total duration threshold, controlling the at least two heating elements to stop working.

4. The method of claim 1, wherein, after the obtaining a battery level parameter of the atomization apparatus, the method comprises:
if the battery level parameter is less than a preset battery level threshold, controlling the atomization apparatus to work in a boost mode, or
if the battery level parameter is greater than or equal to the preset battery level threshold, controlling the atomization apparatus to work in a straight-through chopping mode in which a voltage provided for a heating element of the at least two heating elements in the boost mode is greater than a voltage provided for the heating element in the straight-through chopping mode.

5. The method of claim 1, wherein controlling the atomization apparatus to work in the multi-heating element mode comprises:
controlling, at a same moment, at least two heating elements of the at least two heating elements to work simultaneously; and
if a heating start duration is greater than a preset total duration threshold, controlling the at least two heating elements to stop working.

6. The method of claim 1, wherein, before obtaining the battery level parameter of the atomization apparatus, the method comprises:
determining whether a heating start signal is received; and
if yes, executing the obtaining of the battery level parameter of the atomization apparatus.

7. The method of claim 1, further comprising:
in a working process of the at least two heating elements, if a heating stop signal is received, controlling the at least two heating elements to stop working.

8. An atomization apparatus, comprising:
a power supply module;
a control module;
an output control module; and
at least two heating elements, different heating elements of the at least two heating elements being correspondingly connected to different output control modules,
wherein the power supply module and each output control module of the different output control modules are both connected to the control module, and
wherein the control module is configured to implement the method of claim 1.

9. The atomization apparatus of claim 8, wherein the output control module comprises a straight-through chopper circuit and a boost circuit that are connected to the control module, and both the straight-through chopper circuit and the boost circuit are connected to the at least two heating elements,
wherein the control module is configured to: when a battery level parameter of the atomization apparatus is less than a preset battery level threshold, control both the straight-through chopper circuit and the boost circuit to work, and
wherein the control module is configured to: when the battery level parameter of the atomization apparatus is greater than or equal to the preset battery level threshold, control the straight-through chopper circuit to work, and control the boost circuit to stop working.

10. The atomization apparatus of claim 9, wherein the straight-through chopper circuit comprises an output switching transistor and an output circuit,
wherein a control terminal of the output switching transistor is connected to the control module,
wherein a first terminal of the output switching transistor is connected to the power supply module, and
wherein a second terminal of the output switching transistor is connected to the at least two heating elements through the output circuit.
